(19) United States
(12) Patent Application Publication
(10) Pub. No.: US 2006/0195912 A1
(43) Pub. Date: Aug. 31, 2006

(54) Selectively communicating digital content

(75) Inventors: Donald Dew, Ajax (CA); M. Michael Serbinis, Toronto (CA); Robert Zuber, San Francisco, CA (US)

Correspondence Address: THELEN REID & PRIEST, LLP, P. O. BOX 640640, SAN JOSE, CA, 95164-0640, US

(73) Assignee: Critical Path, Inc., a California Corporation

(21) Appl. No.: 11/352,429

(22) Filed: Feb. 10, 2006

Related U.S. Application Data
(60) Provisional application No. 60/652,261, filed on Feb. 11, 2005.

(51) Int. Cl. H04L 9/32

(52) U.S. Cl. 726/27

(57) ABSTRACT

A method and system for selectively communicating digital content is disclosed. For one embodiment of the invention, digital content communications of a user are analyzed. A rule in regard to communicating the digital content of the user is formulated based upon the analysis of the digital content communications. The rule is then presented to the user and suggested as an additional rule to be applied to the communication of the digital content. Upon acceptance by the user, the rule is implemented and applied to the digital content. For alternative embodiments of the invention, the rule, based upon the analysis of the digital content communications, may be automatically implemented. For one embodiment of the invention, the rule governs whether or not digital content is forwarded to the user's mobile device.

### CROSS-REFERENCE TO RELATED APPLICATION

This application is a non-provisional application claiming priority to provisional application Ser. No. 60/652,261, filed on Feb. 11, 2005, entitled “Message Router and Platform for Routing E-mail Between External E-mail Systems and Simple Hand-held Devices,” which is herein incorporated by reference in its entirety.

### FIELD OF THE INVENTION

Embodiments of the invention relate generally to the field of digital communication systems and more specifically to selectively forwarding digital content to a mobile communications system.

### BACKGROUND OF THE INVENTION

Typical mobile messaging systems allow a user to receive digital content on a mobile communications device (mobile device). The digital content may include e-mail, news feeds (e.g., RSS news feeds), blogs, audio and video clips and multimedia for example, while mobile devices may include hand-held devices such as personal digital assistants (PDAs) and cellular phones or wireless devices having messaging functionality.

Such systems often allow the user to have digital content that is addressed to one or more destinations forwarded to the mobile device. For example, a user may maintain several e-mail accounts and have the e-mail messages that get delivered to all of those accounts subsequently delivered to the mobile device.

A user may wish to have many of the e-mails received through various accounts forwarded to the mobile device, but for a number of reasons may wish that some or even most of the e-mails were not forwarded. For example, typical messaging service providers charge the user based upon the amount of digital content that is forwarded to the mobile device. Having all digital content forwarded to the mobile device may therefore be cost prohibitive and the user may wish to have only that digital content deemed sufficiently important forwarded to the mobile device. Additionally, a user may not have time to respond to all of the digital content in a mobile situation and may therefore desire that only a small subset of the digital content deemed to have the highest priority be forwarded. Moreover, typical mobile devices are limited in their capacity to present digital content and therefore it may be difficult for a user to present and respond to a large amount of digital content using the mobile device.

These disadvantages have been addressed in several ways. For example, e-mail filtering programs exist that are used to identify and reject suspected spam upon receipt. Such filters may also be used to prevent forwarding identified spam to a mobile device. Such e-mail filtering programs generally identify most spam, but occasionally desired messages are blocked as well, presenting the user with the possibility that an important message might not be received. To address this concern a user may implement a whitelist, which is a list of e-mail addresses or domain names from which an e-mail filtering program will allow messages to be received.

Using a whitelist has particular disadvantages. For example, the whitelist requires continual updating and is limited to allowing digital content from addresses or domain names known to the user. In many instances a user may wish to receive digital content from an unknown source and have that digital content forwarded to a mobile device.

Another method of addressing the problem is to implement a set of rules based on the address of the digital content that govern forwarding the digital content to a mobile device for a particular user. However, implementing a set of rules is complex and often beyond the sophistication of most users. The process of implementing a set of rules is time consuming as well, and often the user must access a web-based application to implement the rules. Moreover, a typically user may not be able to determine which rules are required to effect the desired digital content forwarding, and may not be able to accurately implement the rule.

### SUMMARY OF THE INVENTION

In accordance with one embodiment of the invention stored digital content is analyzed. A digital content forwarding rule is formulated based upon the analysis of the stored digital content, and presented to a user. Additionally, or alternatively, rules may be formulated based upon the previous behaviors of the user and relationships between new digital content and previously accepted or denied content.

A response is received from the user regarding the digital content forwarding rule presented, and digital content is forwarded to the user based upon the response.

Other features and advantages of embodiments of the present invention will be apparent from the accompanying drawings, and from the detailed description, that follows below.

### BRIEF DESCRIPTION OF THE DRAWINGS

The invention may be best understood by referring to the following description and accompanying drawings that are used to illustrate embodiments of the invention. In the drawings:

FIG. 1 illustrates a system in which digital content may be selectively communicated in accordance with one embodiment of the invention;

FIG. 2 illustrates a process in which digital content is selectively communicated in accordance with one embodiment of the present invention;

FIG. 3 illustrates a process in which rules governing the selective forwarding of e-mail messages are formulated and implemented in accordance with one embodiment of the invention;

FIG. 4 illustrates a process in which rules governing the selective forwarding of published digital content are formulated and implemented in accordance with one embodiment of the invention; and

FIG. 5 illustrates a functional block diagram of a digital processing system in accordance with one embodiment of the invention.

### DETAILED DESCRIPTION

A method and system for selectively communicating digital content is disclosed. For one embodiment of the invention, digital content communications of a user are analyzed. A rule in regard to communicating the digital content of the user is formulated based upon the analysis of the digital content communications. Additionally, or alternatively, rules may be formulated based upon the previous behaviors of the user and relationships between new digital content and previously accepted or denied content. The rule is then presented to the user and suggested as an additional rule to be applied to the communication of the digital content. Upon acceptance by the user, the rule is implemented and applied to the digital content. For alternative embodiments of the invention, the rule, based upon the analysis of the digital content communications, may be automatically implemented. For one embodiment of the invention, the rule governs whether or not digital content is forwarded to the user's mobile device.

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

Embodiments of the invention are applicable in a variety of settings in which digital content is communicated and selective communication of the digital content may be desired.

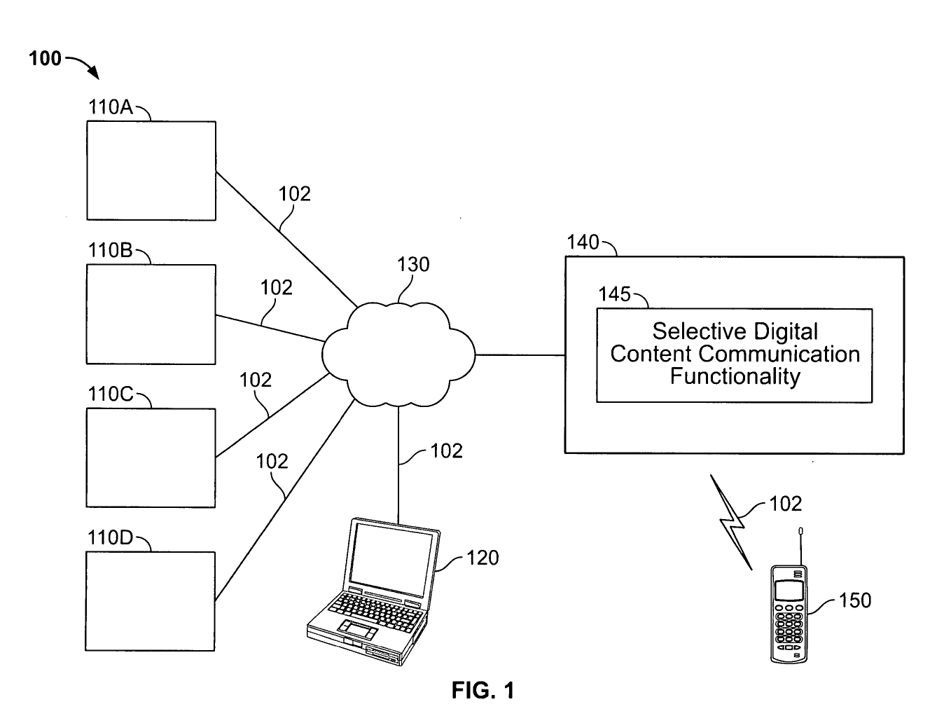

FIG. 1 illustrates a system in which digital content may be selectively communicated in accordance with one embodiment of the invention. System 100, shown in FIG. 1, includes a number of digital content storage devices, shown for example as digital processing systems (DPSs) 110A-110D. The DPSs 110A-110D may be network servers, personal computers, or other types of digital processing systems. The DPSs 110A-110D are configured to store and communicate a plurality of various types of digital content such as e-mails, news feeds, blogs, audio and video clips and multimedia, for example, as well as documents such as web pages, content stored on web pages, including text, graphics, and audio and video content. For example, the stored content may be audio/video files, such as programs with moving images and sound. The DPSs 110A-110D store digital content for a user which may have been communicated from any of a variety of sources, shown for example, as DPS 120.

The stored digital content may be communicated between the DPSs through any type of communications network through which a plurality of different devices may communicate such as, for example, but not limited to, the Internet, a wide area network (WAN) not shown, a local area network (LAN), an intranet, or the like. For example, as shown in FIG. 1, the DPSs are interconnected one to another through Internet 130 which is a network of networks having a method of communicating that is well known to those skilled in the art.

The user may wish to have some portion of the digital content stored on DPSs 110A-110D forwarded to the user's mobile device 150. The mobile service provider's operator network 140 is connected via Internet 130 to the DPSs 110A-110D storing the digital content. Operator network 140, which also has digital processing capabilities, has, in accordance with one embodiment of the invention, a selective forwarding application 145 installed thereon. Application 145 provides selective digital content communication functionality.

The user's mobile device 150, which also has digital processing capability, is connected to the operator network 140. The communication links 102 coupling the DPSs, the operator network, and the mobile device need not be direct links, but may be indirect links, including but not limited to, broadcasted wireless signals, network communications or the like.

In accordance with one embodiment of the invention the application 145 polls the digital content stored on DPSs 110A-110D and determines if there is new digital content to be forwarded to the mobile device. The application 145 applies general and user-specific rules to the digital content to determine whether or not the digital content is forwarded to the mobile device 150. In accordance with one embodiment of the invention, the application 145 analyzes the digital content and formulates rules based upon the analysis. Additionally, or alternatively, rules may be formulated based upon the previous behaviors of the user and relationships between new digital content and previously accepted or denied content.

The formulated rules are then presented to the user, and if accepted by the user are applied to the digital content. In accordance with one such embodiment of the invention the formulated rules are presented to the user and accepted by the user via the mobile device 150.

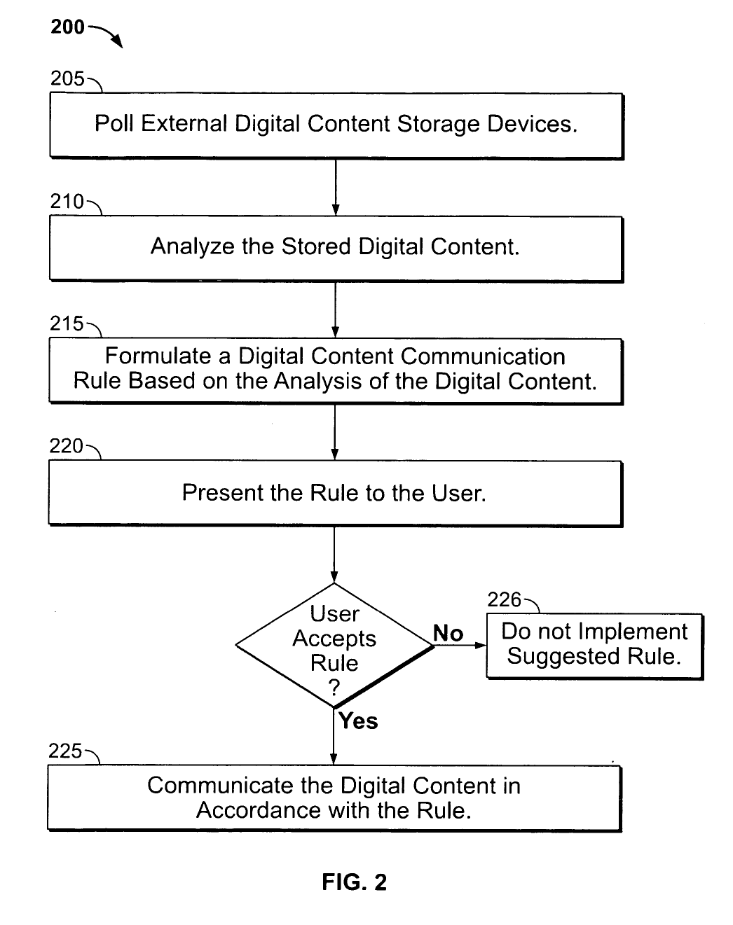

FIG. 2 illustrates a process in which digital content is selectively communicated (e.g., forwarded) in accordance with one embodiment of the present invention. Process 200, shown in FIG. 2, begins with operation 205 in which the selective communication application polls external digital content storage systems (e.g., external e-mail systems) for digital content. For one embodiment of the invention, the digital content storage systems are configured to notify the selective communication application of digital content so polling is not required. For one embodiment of the invention, digital content stored previously in external storage systems as well as digital content presently received (e.g., in the process of being received) is polled.

At operation 210 the selective communication application analyzes the digital content. The analysis of the digital content can take many forms depending on the type of content and the user's response to the content. For example, for e-mails an analysis may be the number of e-mails the user has received from a particular e-mail address or domain name. In general the application analyzes the metadata of the digital content. For one embodiment of the invention, the analysis includes examining existing preferences of the user and determining if the digital content has a threshold correlation or relationship with existing preferences.

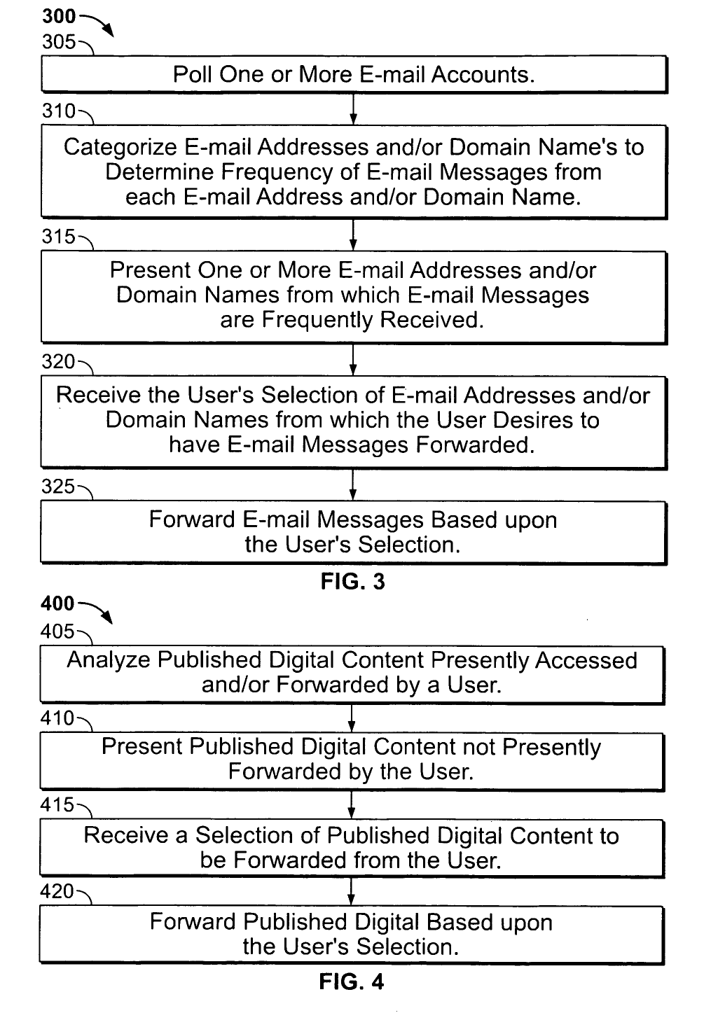

At operation 215 a digital content communication rule is formulated based upon the analysis of the digital content. For example, the rule may be “forward e-mails from a particular e-mail address” where the user has received a threshold number of e-mails from that e-mail address. Or, for example, the rule may be “do not forward e-mails from a particular domain name,” where, even though such e-mails have not been designated as spam, the user has nevertheless shown no interest in e-mails from that domain name. Such an embodiment is discussed more fully below in reference to FIG. 3.

At operation 220 the rule is presented to the user. For one embodiment, the user may be presented with a query such as “Forward all e-mail messages from name.domain.com to the mobile device?” For one embodiment the user may be presented with one or more such queries via the mobile device and can respond via the mobile device as well.

At operation 225, if the user accepts the rule, the user's rules are updated accordingly and digital content is communicated in accordance with the updated rules. For one embodiment of the invention the rule may implemented in regard to subsequently received digital content. Alternatively, the rule may be applied retroactively (e.g., to a specified time) to previously received digital content. The user may accept the rule via the mobile device, and when the user's acceptance is received by the selective forwarding application, the rule is implemented.

At operation 226, if the user's acceptance of the rule is not received, the rule is not implemented.

As discussed above, embodiments of the invention are applicable to a variety of digital content communication including e-mail message forwarding. FIG. 3 illustrates a process in which rules governing the selective forwarding of e-mail messages are formulated and implemented in accordance with one embodiment of the invention. Process 300, shown in FIG. 3 begins at operation 305 in which a user's e-mail accounts are polled. A number of previously received e-mail messages are examined. The number of e-mails examined may be a fixed number or may include all e-mails received after a given date.

At operation 310 the e-mail addresses (and/or domain names) are analyzed and categorized based on frequency of received e-mail messages from those addresses. For one embodiment of the invention, those e-mail messages designated as spam by conventional spam filters are not included in the analysis. The information regarding the highest frequency e-mail addresses or domain names is compiled. For one embodiment of the invention, such information may have a specified limit as to the number of addresses or domain names. For example a list of the ten addresses or domain names from which e-mail messages are most frequently received. Additionally or alternatively, the information may be limited by the number of e-mail messages received from a particular address or domain name. For example, a list of all addresses or domain names from which ten or more e-mail messages have been received in the previous month. For one embodiment of the invention, only those addresses or domain names that were not already part of an e-mail forwarding scheme (e.g., contained on a whitelist) are analyzed.

At operation 315 the list of addresses or domain names from which e-mail messages are frequently received is presented to the user. Accompanying the list may be a message prompting the user to select those addresses or domain names, from the list, from which the user would like e-mail messages to be forwarded (e.g., forwarded to the user's mobile device).

At operation 320 the user selects those addresses or domain names from the list, from which the user desires to have e-mail messages forwarded. For example, the list of addresses or domain names from which e-mail messages are most frequently received may include a checkbox next to each address or domain name, which the user checks to indicate a desire to have e-mail messages from such addresses or domain names forwarded.

At operation 325 the user's selection of addresses and domain names are used to formulate and implement e-mail forwarding rules in regard to forwarding the user's e-mail. For one embodiment of the invention, the user's non-selection of a particular address or domain name may result in the suspension of forwarding e-mail messages from that address or domain name.

At this point, e-mail messages from addresses or domain names selected by the user will be forwarded as directed by the user. For one embodiment of the invention, such e-mail messages will be forwarded to the user's mobile device. For one embodiment of the invention, some or all of the previously received e-mail messages from the selected addresses or domain names will be forwarded. For alternative embodiments, only subsequently received e-mail messages from the selected addresses or domain names will be forwarded.

For alternative embodiments of the invention, the subject matter of the e-mail messages may be used in addition to, or instead of, the address or domain name frequency information to analyze the user's e-mail messages. For such an embodiment, where the user receives a threshold number of e-mail messages pertaining to a particular subject, forwarding e-mail messages having a common or related subject may be suggested to the user in a like manner as described in reference to FIG. 3.

As discussed above, embodiments of the invention are applicable to various other types of digital content as well. FIG. 4 illustrates a process in which rules governing the selective forwarding of published digital content are formulated and implemented in accordance with one embodiment of the invention. Published digital content is digital content such as web-syndicated content that is made generally available to specific groups or the general public. In contrast to e-mail messages, which are delivered to a user, published content is typically stored in general repository where it is located and accessed by a number of users. Process 400, shown in FIG. 4, begins at operation 405 in which the published digital content presently accessed and/or forwarded by a user is analyzed. For example, various characteristics of the published digital content that user accesses or forwards may be analyzed and correlated with similar characteristics of other published digital content not presently selected for forwarding by the user. For one embodiment of the invention, characteristics of the published digital content may be the subject matter of the published digital content or demographic information of users currently accessing the published digital content.

At operation 410 published digital content not presently selected for forwarding by the user is presented to the user based upon the analysis. For one embodiment of the invention each instance of published digital content may be accompanied by a rationale for suggesting the published digital content be forwarded. For example, the subject matter of the digital content presented to the user may have a high correlation to digital content presently selected for forwarding by the user. For example, the published digital content presented may be digital content from a website containing particular subject matter (e.g., gourmet cooking) with an accompanying explanation that the user presently has digital content from several similar websites forwarded. Or, for example, the published digital content presented may be a blog discussing particular subject matter (e.g., sports) with an accompanying explanation that the digital content is typically accessed by users who access published digital content presently forwarded by the user.

At operation 415 the user's selection of published digital content not presently selected for forwarding by the user is received. As discussed above, the user's selection may be the acceptance of a formulated rule such as “always forward the particular published digital content” or may be a response to a query such as “would you like this published digital content forwarded.”

At operation 420 published digital content is forwarded to the user based upon the user's selection.

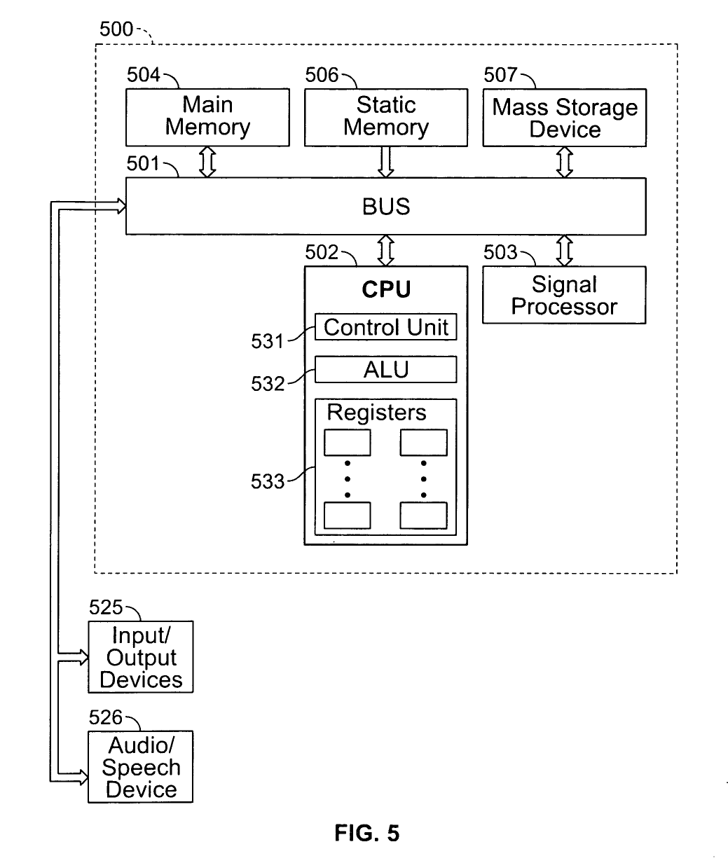

As discussed above, embodiments of the invention may employ DPSs or devices having digital processing capabilities. FIG. 5 illustrates a functional block diagram of a digital processing system in accordance with one embodiment of the invention. The components of processing system 500, shown in FIG. 5 are exemplary in which one or more components may be omitted or added. For example, one or more memory devices may be utilized for processing system 500.

Referring to FIG. 5, processing system 500 includes a central processing unit 502 and a signal processor 503 coupled to a main memory 504, static memory 506, and mass storage device 507 via bus 501. In accordance with an embodiment of the invention, main memory 504 may store a selective communication application, while mass storage devise 507 may store various digital content as discussed above. Processing system 500 may also be coupled to input/output (I/O) devices 525, and audio/speech device 526 via bus 501. Bus 501 is a standard system bus for communicating information and signals. CPU 502 and signal processor 503 are processing units for processing system 500. CPU 502 or signal processor 503 or both may be used to process information and/or signals for processing system 500. CPU 502 includes a control unit 531, an arithmetic logic unit (ALU) 532, and several registers 533, which are used to process information and signals. Signal processor 503 may also include similar components as CPU 502.

Main memory 504 may be, e.g., a random access memory (RAM) or some other dynamic storage device, for storing information or instructions (program code), which are used by CPU 502 or signal processor 503. Main memory 504 may store temporary variables or other intermediate information during execution of instructions by CPU 502 or signal processor 503. Static memory 506, may be, e.g., a read only memory (ROM) and/or other static storage devices, for storing information or instructions, which may also be used by CPU 502 or signal processor 503. Mass storage device 507 may be, e.g., a hard or floppy disk drive or optical disk drive, for storing information or instructions for processing system 500.

General Matters

Embodiments of the invention include a system that analyzes digital content for a user and based upon this analysis formulates rules for selectively forwarding the digital content. Additionally, or alternatively, rules may be formulated based upon the previous behaviors of the user and relationships between new digital content and previously accepted or denied content. In accordance with one embodiment of the invention the rules may then be presented to the user in easily comprehensible terms. The user may accept, reject or ignore the suggested rules. Thus the user can have a set of rules governing communication of digital content implemented without expending the time and effort of formulating or implementing the rules.

Embodiments of the invention have been described as including various operations. Many of the processes are described in their most basic form, but operations can be added to or deleted from any of the processes without departing from the scope of the invention.

The operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection). All operations may be performed at the same central cite or, alternatively, one or more operations may be performed elsewhere.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
analyzing stored digital content;
formulate a digital content communication rule based upon the analysis of the stored digital content;
present the digital content communication rule to a user;
receive a response from the user regarding the digital content communication rule presented; and
forward digital content to the user based upon the response.

2. The method of claim 1, wherein the digital content communication rule is presented to a user via a mobile communications device.

3. The method of claim 1, wherein in the stored digital content comprises e-mail messages of the user contained in one or more e-mail accounts.

4. The method of claim 1, wherein the stored digital content is digital content selected from the group consisting of e-mail messages, news feeds, blogs, audio content, video content, and combinations thereof.

5. The method of claim 3, wherein the digital content communication rule is based upon the frequency of e-mail messages received from a particular source.

6. The method of claim 1, wherein the digital content communication rule is based upon previous digital content communication decisions of the user.

7. The method of claim 1, wherein the digital content communication rule is based upon digital content communication decisions of one or more other users.

8. The method of claim 5 further comprising:
designating one or more e-mail messages as spam; and
disregarding e-mail messages designated as spam during the analysis of the stored digital content.

9. The method of claim 6, wherein the digital content communication rule is based upon a correlation between a subject matter of the stored digital content and a subject matter of digital content presently selected for forwarding by the user.

10. A system comprising:
one or more digital content storage devices storing digital content;
one or more communication devices capable of receiving and presenting digital content; and
a digital content communication device coupling at least one of the digital content storage devices to at least one of the communication devices, the digital content communication device having a selective communication application that analyzes stored digital content, formulates a digital content communication rule based upon the analysis of the stored digital content, and presents the digital content communication rule to a user.

11. The system of claim 10 wherein the selective communication application further receives a response from the user regarding the digital content communication rule presented and forwards digital content to the user based upon the response.

12. The system of claim 10 wherein the digital content storage devices are configured to notify the selective communication application of digital content.

13. The system of claim 10, wherein the one or more communications devices are mobile communications device.

14. The system of claim 10 wherein the one or more digital content storage devices are coupled to the digital content communication device through a communications network selected from the group consisting of the Internet, a wide area network, a local area network, an intranet, and combinations thereof.

15. The system of claim 10, wherein in the stored digital content comprises e-mail messages of the user contained in one or more e-mail accounts and the digital content communication rule is based upon the frequency of e-mail messages received from a particular source.

16. The system of claim 10, wherein the stored digital content is digital content selected from the group consisting of e-mail messages, news feeds, blogs, audio content, video content, and combinations thereof.

17. The system of claim 16, wherein the digital content communication rule is based upon previous digital content forwarding decisions of the user.

18. The system of claim 16, wherein the digital content communication rule is based upon digital content communication decisions of one or more other users.

19. The system of claim 15 wherein the selective communication application further designates one or more e-mail messages as spam and disregards e-mail messages designated as spam during the analysis of the stored digital content.

20. The system of claim 16, wherein the digital content communication rule is based upon a correlation between a subject matter of the stored digital content and a subject matter of digital content presently selected for forwarding by the user.

21. A machine-readable medium that provides executable instructions, which when executed by a processor, cause the processor to perform a method, the method comprising:
analyzing stored digital content;
formulate a digital content communication rule based upon the analysis of the stored digital content;
present the digital content communication rule to a user;
receive a response from the user regarding the digital content communication rule presented; and
forward digital content to the user based upon the response.

22. The machine-readable medium of claim 21, wherein the digital content communication rule is presented to a user via a mobile communications device.

23. The machine-readable medium of claim 21, wherein in the stored digital content comprises e-mail messages of the user contained in one or more e-mail accounts.

24. The machine-readable medium of claim 21, wherein the stored digital content is digital content selected from the group consisting of e-mail messages, news feeds, blogs, audio content, video content, and combinations thereof.

25. The machine-readable medium of claim 23, wherein the digital content communication rule is based upon the frequency of e-mail messages received from a particular source.

26. The machine-readable medium of claim 21, wherein the digital content communication rule is based upon previous digital content forwarding decisions of the user.

27. The machine-readable medium of claim 21, wherein the digital content communication rule is based upon digital content communication decisions of one or more other users.

28. The machine-readable medium of claim 25 further comprising:
designating one or more e-mail messages as spam; and
disregarding e-mail messages designated as spam during the analysis of the stored digital content.

29. The machine-readable medium of claim 26, wherein the digital content communication rule is based upon a correlation between a subject matter of the stored digital content and a
subject matter of digital content presently selected for forwarding by the user.
